(19) United States
(12) Patent Application Publication
(10) Pub. No.: US 2025/0376329 A1
(43) Pub. Date: Dec. 11, 2025

(54) Hay Bale Lift Assisting Device

(71) Applicant: Bryant A. Tyler, Fresno, TX (US)

(72) Inventor: Bryant A. Tyler, Fresno, TX (US)

(21) Appl. No.: 18/737,117

(22) Filed: Jun. 7, 2024

(51) Int. Cl. B65G 7/12

(52) U.S. Cl. CPC B65G 7/12

(57) ABSTRACT

A hay bale lift assisting device includes a panel having a central section and a skirt extending around the central section. A peripheral edge of the skirt has a plurality of corner sections. Each of the corner sections is concavely arcuate such that the skirt includes a plurality of projecting sections between adjacently positioned pairs of the corner sections. Each of a plurality of loops is coupled to the skirt. Each loop is positioned at an associated end of an associated one of the corner sections. Opposed ends of each of a pair of straps are couplable to a selectable one of the loops such that the straps secure the panel to a hay bale extending over the hay bale. The pair of straps can be grasped to facilitate lifting of the hay bale.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to lifting devices and more particularly pertains to a new lifting device for providing engagement and grasping of a hay bale to facilitate lifting the hay bale by a person.

### (2) Description of Related Art Including Information Disclosed Under 37 CFR 1.97 and 1.98

The prior art relates to lifting devices. What is lacking in known prior art is a netting panel which wraps up and around a hay bale with straps to form handles to facilitate lifting of the hay bale.

### BRIEF SUMMARY OF THE INVENTION

An embodiment of the disclosure meets the needs presented above by generally comprising a panel including a central section and a skirt coupled to and extending around the central section. A peripheral edge of the skirt has a plurality of corner sections. Each of the corner sections is concavely arcuate such that the skirt includes a plurality of projecting sections between adjacently positioned pairs of the corner sections of the peripheral edge of the skirt. Each of a plurality of loops is coupled to the skirt. Each loop is positioned at an associated end of an associated one of the corner sections. Opposed ends of each of a pair of straps are couplable to a selectable one of the loops such that the straps secure the panel to a hay bale extending over the hay bale. The pair of straps can be grasped to facilitate lifting of the hay bale.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a hay bale lift assisting device according to an embodiment of the disclosure.

FIG. 2 is a top front side perspective view of an embodiment of the disclosure in use.

FIG. 3 is a top view of an embodiment of the disclosure.

FIG. 4 is a bottom view of an embodiment of the disclosure.

FIG. 5 is a front perspective view of an embodiment of the disclosure in use.

FIG. 6 is a top view of an embodiment of the disclosure.

FIG. 7 is a top view of an embodiment of the disclosure in use.

FIG. 8 is a top view of an embodiment of the disclosure.

### DETAILED DESCRIPTION OF THE INVENTION

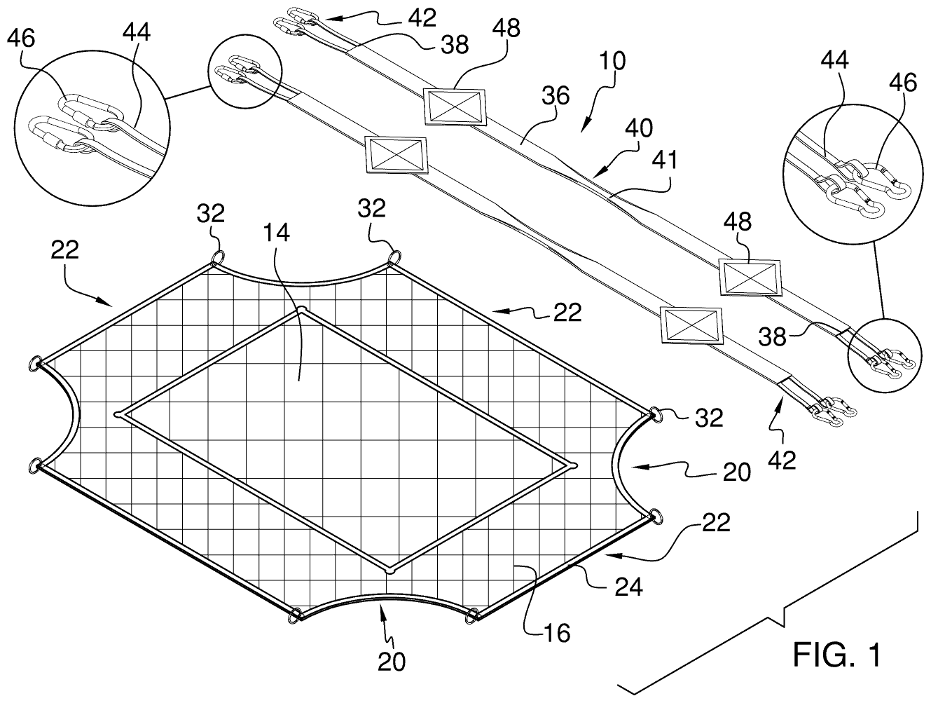

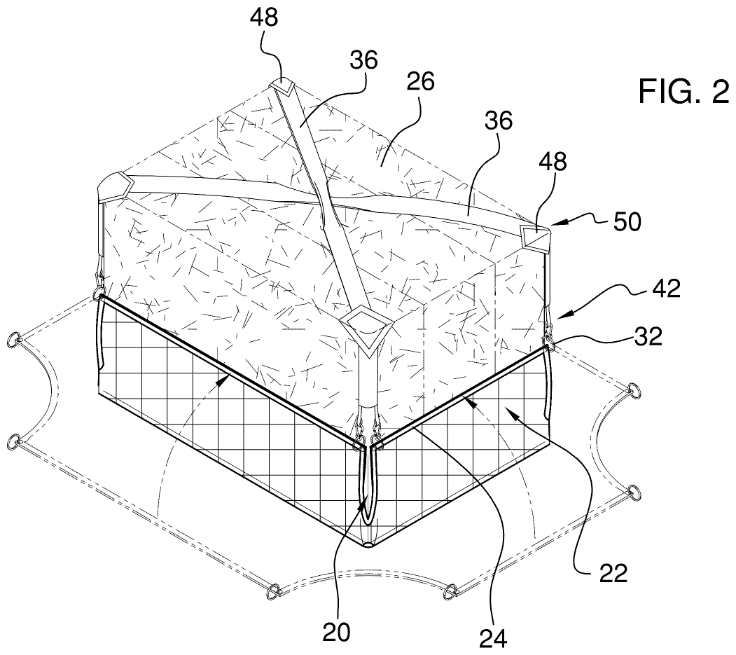

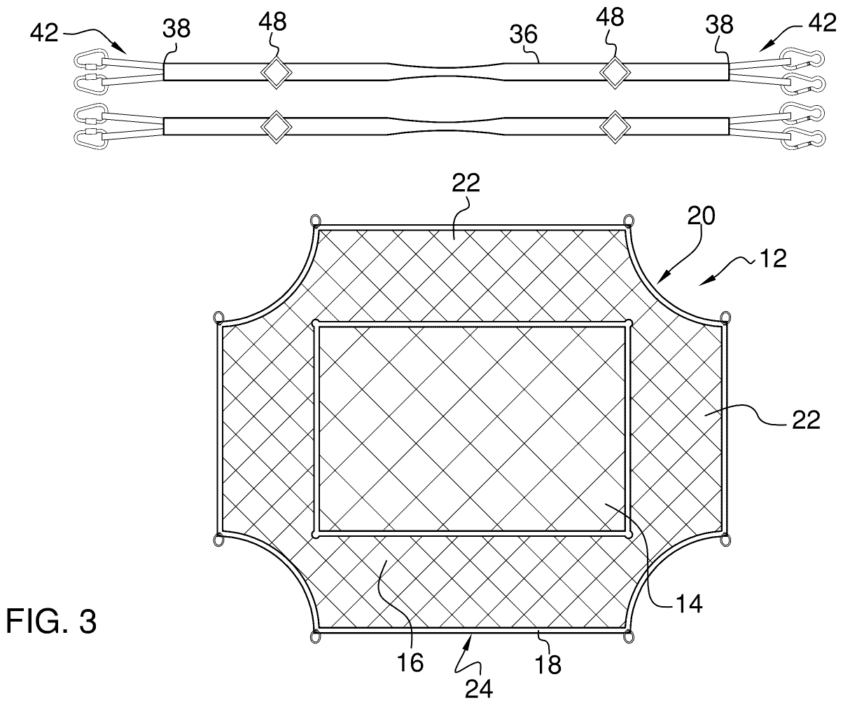

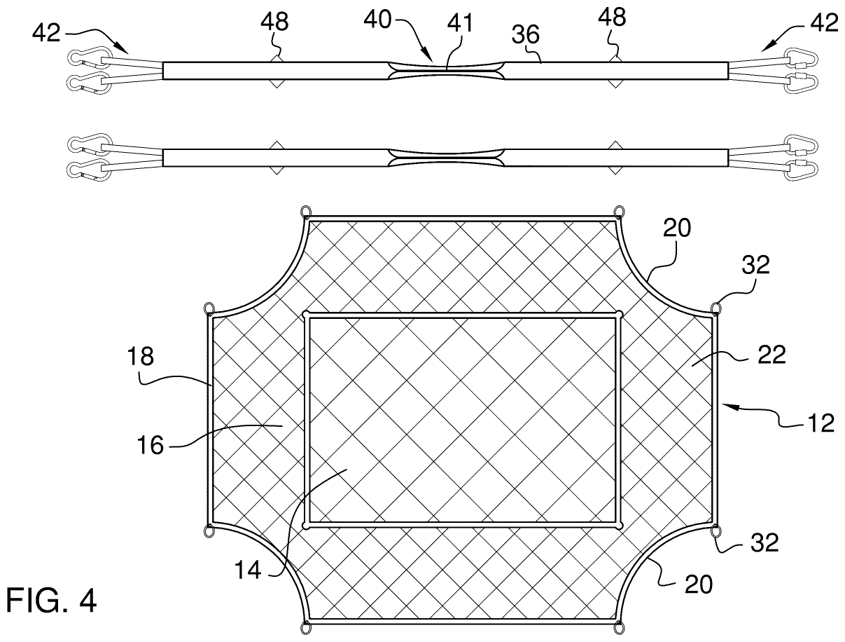

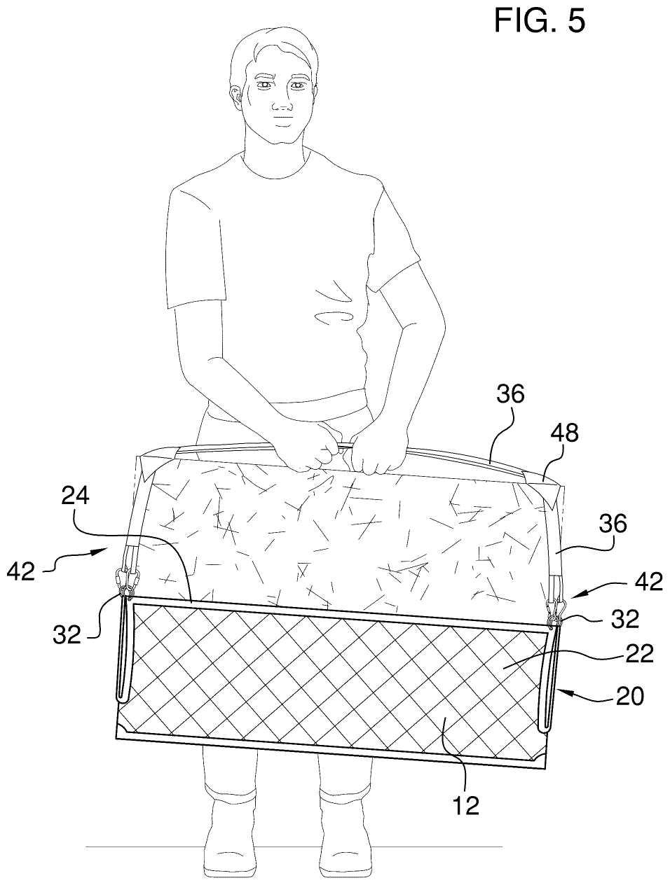

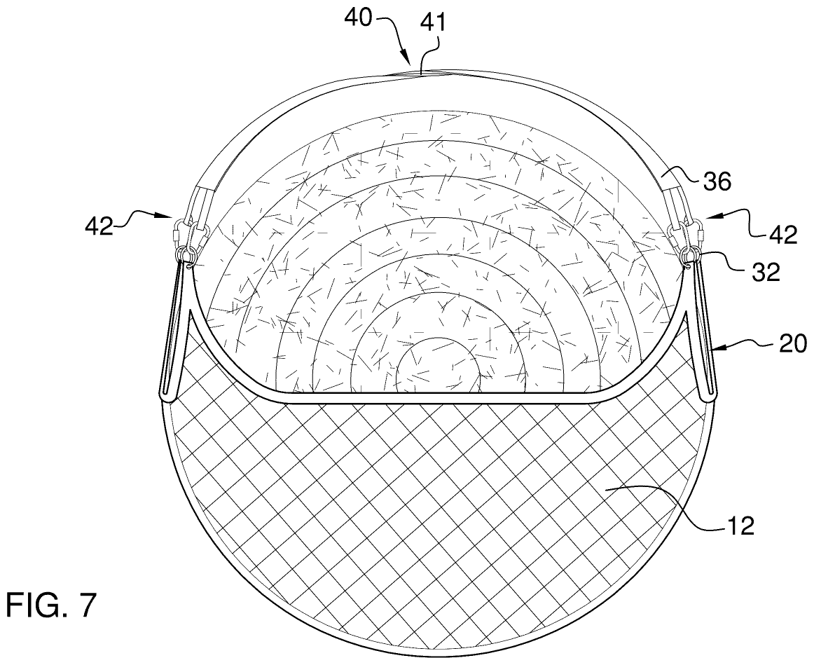

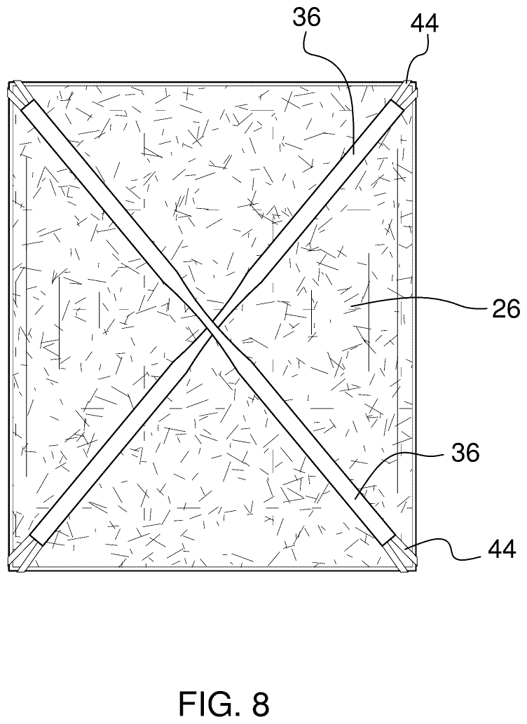

With reference now to the drawings, and in particular to FIGS. 1 through 8 thereof, a new lifting device embodying the principles and concepts of an embodiment of the disclosure and generally designated by the reference numeral 10 will be described.

As best illustrated in FIGS. 1 through 8, the hay bale lift assisting device 10 generally comprises a panel 12. The panel 12 includes a central section 14 and a skirt 16 coupled to and extending around the central section 14. The central section 14 is a mesh material and may be a padded mesh material to define a padded mesh central section. A peripheral edge 18 of the skirt 16 has a plurality of corner sections 20. Each of the corner sections 20 is concavely arcuate relative to peripheral edge 18. Thus, the skirt 16 includes a plurality of projecting sections 22 between adjacently positioned pairs of the corner sections 20 of the peripheral edge 18 of the skirt 16. The peripheral edge 18 of the skirt 16 includes a plurality of straight sections 24 extending between the adjacently positioned pairs of the corner sections 20 of the peripheral edge 18 of the skirt 16. Each of the straight sections 24 is parallel to an oppositely positioned one of the straight sections 24. Each of the straight sections 24 may further be perpendicular to an adjacently positioned pair of the straight sections 24 wherein the peripheral edge 18 of the panel 12 is generally rectangular but for the corner sections 20. The panel 12 may be sized to correspond any hay bale 26 such that the central section 14 is centered under the hay bale 26 and each projecting section 22 curves around a lowermost edge 28 along a respective side 30 of the hay bale 26. This positions each straight section 24 within a single plane parallel to a bottom surface of the hay bale 26 when lifting the hay bale 26 as described further below.

Each of a plurality of loops 32 is coupled to the skirt 16. Each loop 32 is positioned at an associated end 34 of an associated one of the corner sections 20 of the peripheral edge 18 of the skirt 16. Each of a pair of straps 36 has opposed ends 38 and each strap 36 is couplable to a selectable one or more of the loops 32. Thus, the straps 36 are configured for securing the panel 12 to the hay bale 26 such that the pair of straps 36 extends over the hay bale 26. The pair of straps 36 are further configured for being grasped to facilitate lifting of the hay bale 26. Each strap 36 has a gathered section 40 defining a handle section 41 of the strap 36. The gathered section 40 of each strap 36 is centered between opposed ends 38 of the strap 36. The straps 36 may be attached to the loops 32 by a plurality of clips 42. Each end 38 of each strap 36 of the pair of straps 36 has two clips 42 of the plurality of clips 42 coupled to the end 38 of the strap 36. Each clip 42 may have a tether 44 attached to the strap 36 and a carabiner 46 or similar mechanism for attachment to the loop 32. The straps 36 and clips 42 have a combined length such that the straps 36 are configured to cross over a top 46 of the hay bale 26 when the straps 36 are coupled to diagonally opposed loops 32.

Each of a plurality of guards 48 may be coupled to an associated one of the straps 36. Each guard 48 is positioned on the associated strap 36 such that each guard 48 of the plurality of guards 48 is configured to align with a respective upper corner 50 of the hay bale 26. The guards 48 further secure the straps 36 into a position cradling the hay bale 26 with the panel 12. Each guard 48 comprises a cup-shape wherein each guard 48 is configured for complementing a shape of the respective upper corner 50 of the hay bale 26.

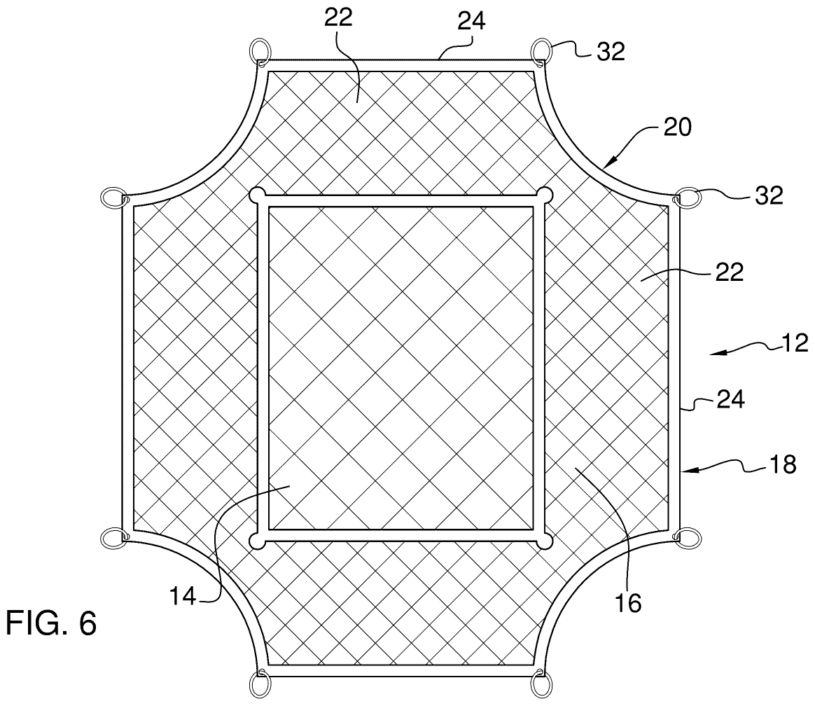

The panel 12 may also be shaped to extend around cylindrical or square hay bales 26 as shown in FIGS. 6 through 8.

In use, the hay bale 26 may be rolled into position centered on the panel 12. Each end 38 of the straps 36 is attached to associated loops 32 by clips 42 with the straps 36 extending over the hay bale 26 and the guards 48 covering the upper corners 50 of the hay bale 26. The hay bale 26 may then be lifted using the handle sections 40 of the straps 36. The straps 36 may cross diagonally over the hay bale 26 with the handle sections 40 crossing each other to allow for connection to a coupler or line to facilitate lifting of the hay bale 26 using a machine, pulley, or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hay bale lift assisting device comprising:
a panel, said panel including a central section and a skirt coupled to and extending around said central section, a peripheral edge of said skirt having a plurality of corner sections, each of said corner sections being concavely arcuate wherein said skirt includes a plurality of projecting sections between adjacently positioned pairs of the corner sections of the peripheral edge of the skirt;
a plurality of loops coupled to said skirt, each loop being positioned at an associated end of an associated one of said corner sections of said peripheral edge of said skirt; and
a pair of straps, opposed ends of each strap being couplable to a selectable one of said loops wherein said straps are configured for securing said panel to a hay bale such that said pair of straps extends over the hay bale whereby said pair of straps are further configured for being grasped to facilitate lifting of the hay bale.

2. The hay bale lift assisting device of claim 1, wherein said central section is a mesh material.

3. The hay bale lift assisting device of claim 1, wherein said central section defines a padded mesh section.

4. The hay bale lift assisting device of claim 1, further comprising said peripheral edge of said skirt including a plurality of straight sections extending between said adjacently positioned pairs of said corner sections of said peripheral edge of said skirt.

5. The hay bale lift assisting device of claim 4, further comprising each of said straight sections being parallel to an oppositely positioned one of said straight sections.

6. The hay bale lift assisting device of claim 5, further comprising each of said straight sections being perpendicular to an adjacently positioned pair of said straight sections.

7. The hay bale lift assisting device of claim 1, further comprising a plurality of clips, each of said clips being positioned at an associated end of an associated one of said straps.

8. The hay bale lift assisting device of claim 1, further comprising a plurality of clips, each end of each strap of said pair of straps having two clips of said plurality of clips being coupled to said end of said strap.

9. The hay bale lift assisting device of claim 1, further comprising a plurality of guards, each guard being coupled to an associated one of said straps, each guard being positioned on said associated strap wherein each guard of said plurality of guards is configured to align with a respective upper corner of the hay bale.

10. The hay bale lift assisting device of claim 9, further comprising each guard comprising a cup-shape wherein each guard is configured for complementing a shape of said respective upper corner of the hay bale.

11. The hay bale lift assisting device of claim 1, further comprising each strap having a gathered section defining a handle section of said strap.

12. The hay bale lift assisting device of claim 11, further comprising said gathered section of each strap being centered between opposed ends of said strap.

13. The hay bale lift assisting device of claim 7, further comprising said straps and clips having a combined length such that said straps are configured to cross over a top of the hay bale when said straps are coupled to diagonally opposed loops.

14. A hay bale lift assisting device comprising:
a panel, said panel including a central section and a skirt coupled to and extending around said central section, said central section being a mesh material and defining a padded mesh section, a peripheral edge of said skirt having a plurality of corner sections, each of said corner sections being concavely arcuate wherein said skirt includes a plurality of projecting sections between adjacently positioned pairs of the corner sections of the peripheral edge of the skirt, said peripheral edge of said skirt including a plurality of straight sections extending between said adjacently positioned pairs of said corner sections of said peripheral edge of said skirt, each of said straight sections being parallel to an oppositely positioned one of said straight sections, each of said straight sections being perpendicular to an adjacently positioned pair of said straight sections;
a plurality of loops coupled to said skirt, each loop being positioned at an associated end of an associated one of said corner sections of said peripheral edge of said skirt;
a pair of straps, opposed ends of each strap being couplable to a selectable one of said loops wherein said straps are configured for securing said panel to a hay bale such that said pair of straps extends over the hay bale whereby said pair of straps are further configured for being grasped to facilitate lifting of the hay bale, each strap having a gathered section defining a handle section of said strap, said gathered section of each strap being centered between opposed ends of said strap;
a plurality of clips, each end of each strap of said pair of straps having two clips of said plurality of clips being coupled to said end of said strap, said straps and clips having a combined length such that said straps are configured to cross over a top of the hay bale when said straps are coupled to diagonally opposed loops; and
a plurality of guards, each guard being coupled to an associated one of said straps, each guard being positioned on said associated strap wherein each guard of said plurality of guards is configured to align with a respective upper corner of the hay bale, each guard comprising a cup-shape wherein each guard is configured for complementing a shape of said respective upper corner of the hay bale.
